(19) United States
(12) Patent Application Publication
(10) Pub. No.: US 2010/0187291 A1
(43) Pub. Date: Jul. 29, 2010

(54) METHOD AND APPARATUS FOR THE TEMPERATURE-CONTROLLED SHAPING OF HOT-ROLLED STEEL MATERIALS

(75) Inventors: Wolfgang Kriegner, Offering (AT); Hans-Jörg Kirchweger, St. Valentin (AT); Karl-Heinz Krenn, Liaz (AT)

Correspondence Address: Setter Roche LLP, P.O. Box 780, Erie, CO, 80516, US

(73) Assignee: VOESTALPINE ANARBEITUNG GMBH, LINZ (AT)

(21) Appl. No.: 12/527,855

(22) PCT Filed: Jan. 15, 2008
(86) PCT No.: PCT/EP08/00261

§ 371 Date: Mar. 5, 2010

(30) Foreign Application Priority Data
Feb. 19, 2007 (DE) 10 2007 008 117.2

(51) Int. Cl. B23K 31/02; B21D 31/00; B21D 37/16

(52) U.S. Cl. 228/173.6; 72/379.2; 72/364

(57) ABSTRACT

The invention relates to a method for shaping sheet steel. In said method, a blank is produced from the sheet steel, the blank is inserted into a shaping tool, and the shaped workpiece is produced from the blank in a one-stage process by means of the shaping tool. Before being shaped, the blank is heated to such a degree that the steel does not undergo any phase transition and the blank is shaped in the ferritic, pearlitic, or bainitic range without exceeding the eutectoid temperature or the recrystallization temperature. The invention also relates to an apparatus for carrying out said method.

### FIELD OF THE INVENTION

The invention relates to a method and an apparatus for the temperature-controlled forming of hot rolled steel material.

### BACKGROUND OF THE INVENTION

It is known to produce suitable components out of sheet steel by means of forming methods such as deep-drawing. Both hot rolled and hot- and cold rolled steel grades are used for this.

Forming methods of this kind can be carried out both as hot forming methods and as cold forming methods.

In general, the term “hot forming” refers to a forming in the austenitic range. In it, the maximum temperature of 980° C. should not be exceeded if no additional annealing is to take place. Furthermore, the forming must be completed at a temperature above 750° C. and the cooling must then be carried out in still air. Only steels for normalized annealing can be used for this process because they maintain their strengths even after an annealing at 950° C.

The sequence of this process is shown in FIG. 18. In this case, the blank 101, which in most cases is cut to the final contour, is inserted into the first part 102 of the mold 103 and formed in a free-floating fashion. In the course of this, as shown in step 2 of the drawing, the blank 101 becomes dished at the bottom. In this process, the blank 101 can be immobilized in the mold 103 only in the neutral position before the deforming. As soon as the top part 104 of the mold 103 comes into contact with the blank 101, an unguided, free-floating forming occurs (FIG. 18 top). After this forming, the blank 101 is shifted into the second mold 105 (FIG. 18 bottom). In this step, the edges 106 and radii 107 of the work piece are upset. If so desired, a stamping of the welding edge can take place at the same time. But since the molding occurs in a free-floating fashion, a dimensionally accurate stamping of the edges can only be achieved with difficulty. During the stamping, an opposite dishing 108 of the component occurs. In the course of this, material is displaced into the bottom and not used for the stamping. But this requires large upsetting distances in order to achieve the dimensional accuracy of the edge and radii. In other words, the mold is necessarily subject to a high rate of wear due to the large upsetting distances. In addition, it is necessary to take into account the fact that two parts must be in the press at all times in this process. But this in turn compensates for the reduction in pressing force due to the high forming temperature.

Typical components that are manufactured in this way include axle beams of commercial vehicles. In this case, the hot forming is used to reduce the forming force and the bending radii. At the same time, in a second step, the bending edges can be upset, giving the component a higher rigidity.

A method of this kind is known, for example, from U.S. Pat. No. 2,674,783. In this method, in the first step, a shape is produced and then in a second operation, this preliminary shape is subjected to a finish stamping.

One disadvantage of this manufacturing method is that the work piece must be handled twice. In the course of this, different cooling rates occur. Depending on the mold temperature, the cooling rate in the mold can be higher or lower than in still air. As will be described in further detail, the cooling is very important in normalized annealed steels.

Because of the two-step process, the decrease in component temperature intensifies. As a result, the forming forces rise and especially during calibration, i.e. the process step with the highest forming force, the forming resistance is very high, thus diminishing the advantage of hot forming. Furthermore, it is necessary to assure that the second forming is completed at a temperature above 750° C. or 700° C.

However, tests with a preheated mold, i.e. conditions approximating those in production, demonstrate that in comparison to cooling in air, the cooling rate is significantly higher as a result of the hot forming (FIG. 19).

In all of the tests, the temperatures in the component were measured in an online fashion by means of thermocouple elements. The thermocouple elements were inserted into oblong holes with a diameter of 2 mm and formed along with the work piece.

FIG. 20 shows a detailed examination of the forming process. It is clear here that the first forming step is completed at approximately 790° C. and the second forming step is completed at approximately 680° C. But this means that the temperature falls below the minimum forming temperature of 750° C. or 700° C. It is also clear in FIG. 19 that the transformation from ferrite into austenite takes place either between the forming stages or during the forming. The exact transformation temperature depends on the alloy composition. The final temperature also demonstrates that the advantages of hot forming, i.e. lower forming forces, no longer apply in the second forming stage.

The selection of steels for hot forming methods of this kind is limited to normalized annealed steels.

Normalized annealed and normalized rolled steels attain their mechanical properties both in the initial state (normalized rolled) and in the annealed state, provided that this is a normalized annealing. The heat treatment occurs above the A3 temperature. In other words, an annealing takes place in the single-phase austenitic range. If these steels are cold formed, then when a forming ratio of 5% is exceeded, a heat treatment should be carried out.

The mechanical characteristic values are mainly achieved through the formation of a ferritic/perlitic matrix. This means, however, that the cooling speed must be exactly maintained in order to assure the formation of a finely laminated perlite. The cooling must occur slowly, either in still air or in the furnace. It is necessary to assure that the ferrite and perlite phases are precipitated and the formation of martensite is prevented. Below 600° C., the cooling speed is not critical. The strength of the material depends in linear fashion on the proportion of perlite, which in turn depends on the carbon content. By and large, an increase in strength can only be achieved through an increase in the carbon content. As a further consequence, however, this means that the weldability decreases. This is visible through the increase in the carbon equivalent (see FIG. 15).

Steels that are annealed in a normalizing fashion can be differentiated between normalized rolled products and normalized annealed products; in the manufacture of normalized rolled products, care must be taken that the final hot rolling occurs above the recrystallization temperature of the austenite. Typically, this is approximately 950° C.

The steel recrystallizes completely and the rolling direction is only discernable due to segregation effects. The recrystallized austenite then transforms into ferrite and perlite with a definite cooling speed. In normalized annealed products, blanks or components are heated to temperatures above the A3 temperature and then cooled in a controlled fashion. After this heat treatment, the steel regains its initial properties. Furthermore, after an annealing, the blank or component can be formed away from the heat. It should be noted, however, that the forming must be completed at a temperature above 750° C. With a forming ratio of no more than 5%, this temperature limit is 700° C. The blanks or components must be cooled in still air.

Thermomechanically rolled steels owe their strength to intentional manufacture during hot-rolling. In this case, the final deformation is carried out below the recrystallization temperature of the austenite. The temperature control of the recrystallization is carried out through the use of additional alloy elements. These elements, particularly niobium in this case, increase the recrystallization temperature of the austenite, yielding a sufficient process window between the A3 temperature and the recrystallization temperature.

Since the structure can no longer recrystallize after the last rolling pass, due to its stretched, rolled structure, it has a very large number of germs for the transformation of austenite into ferrite. This results in a very fine-grained structure that is chiefly composed of ferrite and contains smaller portions of bainite. Bainite is a very finely laminated perlite that can only solidify in disequilibrium. This occurs through a controlled rapid cooling after the last rolling pass. As an additional effect, an increase in the toughness of the material occurs.

Solidification in equilibrium requires slow cooling rates; this is more applicable to normalized rolled steels. In addition, the alloy elements in the form of precipitated carbides, nitrides, or carbon nitrides prevent a grain growth at temperatures above 1100° C. This also has an advantageous effect on the coarse grain zone of the thermal influence zone during welding.

Because of their alloy composition, at high strengths, normalized annealed steels exhibit a critical behavior in their manufacture into hot rolled strips. Due to the low alloy content in TMT steels, they can be produced with significantly higher strengths.

Whereas normalized rolled steels are only normalized up to a maximum yield point of 460 MPa at sheet thicknesses below 16 mm, TMT steels are normalized up to a minimum yield point of 700 MPa at 8 mm (>8 mm, the yield point may be 20 MPa lower). These specifications can be found in the standard DIN EN 10025-3 for normalized rolled steels; thermomechanically rolled steels are covered by the standard DIN EN 10149-2.

Sour gas-resistant steels are manufactured in the same process as thermomechanical steels. Due to their field of application, however, they are covered by the standard API spec. 51 and DIN EN 10208-2. These sheets are characterized by extremely low contents of impurities such as sulfur. This prevents a recombination of the hydrogen into H₂, i.e. a formation of cracks in the vicinity of manganese sulfides. In addition, this significantly improves the toughness, even at very low temperatures. The low carbon content also reduces the occurrence of middle segregation. This prevents the formation of hard phases in the matrix. In order to increase the strength, the final cooling temperature must be reduced. This yields a steel with a very fine ferritic structure.

FIG. 16 shows a comparison of the manufacturing paths in the hot-rolling plant. The difference in the final deformation is clearly visible here. The cooling conditions away from the rolling heat can be used to further influence the structural evolution during thermomechanical rolling. The different structures of normalized rolled, normalized annealed, and thermomechanically rolled steels are shown in FIG. 17.

The abbreviations in FIG. 16 are T (temperature), TRS (recrystallization temperature in the austenite), TM (thermomechanical), and ACC (accelerated cooled).

If the structures of normalized rolled and TM-rolled are compared, the increased content of carbon-rich perlite (dark phase) is clearly visible. A grain refinement and consequently an increase in strength, ductility, and toughness is only possible through thermomechanical manufacturing.

The chemical compositions of normalized rolled steel are found in the standards DIN EN 10149-3 and DIN EN 10025-3. The chemical composition of thermomechanically rolled steel is given in the standard DIN EN 10149-2. If a comparison is made of steel grades with the same minimum yield point, the higher carbon contents in normalized rolled steels are clearly evident.

U.S. Pat. No. 5,454,888 has disclosed a method for manufacturing high-strength steel components, which are to be hot formed at 300° F. (149° C.) to 1200° F. (649° C.). The material used should have a ferritic/perlitic structure. The publication does not discuss a particular shape. EP 0 055 436 has disclosed a method for reducing springback in mechanically pressed sheet material in which a counterpressure is to be used during the forming. The counterpad pressure in this press should in particular control the positioning of the sheet material in the press. This publication, however, does not disclose any forming temperatures or the material to be formed.

For cold forming, both steel grades can be used; thermomechanical steels have a better forming capacity at equivalent yield points. A stamping of the edges or a welding seam preparation is not possible in cold forming since the forces that occur would be too great. For this reason, an economical design of a press for components with complex geometry is no longer possible.

The object of the invention is to create a method that can be carried out simply and quickly, is improved with regard to wear on the mold, and yields a process that can be better controlled at lower costs.

Another object of the invention is to create an apparatus for carrying out the method, with which the forming is carried out simply, quickly, and safely, which has a low amount of wear, functions at a high clock cycle rate, and reduces investment costs.

### SUMMARY OF THE INVENTION

In the method according to the invention, the material is in fact heated, but does not undergo a phase transformation, i.e. the forming occurs in the ferritic, perlitic, or bainitic range. The process temperature is not permitted to exceed either the eutectoid temperature or the recrystallization temperature.

For this method, it is possible to use steels that have a stable structure at temperatures of up to a maximum of 700° C.

In addition to normalized rolled steels, these primarily include thermomechanically rolled steels since they have a stable structure. These steels are also approved for low-tension annealing, which occurs in approximately the same temperature range. When using these steels, care must be taken to prevent recrystallization from occurring during the heating and subsequent forming.

Among other things, multiphase steels also contain martensitic phases in the matrix. This martensite, however, is annealed at very high temperatures and thus changes the mechanical characteristic values of the steel grade.

The method according to the invention advantageously enables scale-free forming. Whereas with known forming processes at temperatures of 900° C. and above, thick layers of scale form, in this case, only thin oxide skins form on the surface of the work piece. If an unheated hot rolled strip is compared to the components formed according to the invention, there is no visible difference in the surface appearance.

This makes it possible to integrate several process steps into one mold since undesirable scaling cannot negatively affect the function. Thus in the case of the temperature-controlled forming in the above-mentioned two-stage process according to the invention, it is possible to use the dual-action process for stamping sharp radii according to the prior art. This process is in fact carried out at lower temperatures than the hot forming, but since only one work piece is present in the press, pressing forces are likewise low. This process makes it possible to combine several process steps in one mold:
guided forming
upsetting of material
stamping of welding edges
component ejection

The cost savings are achieved for the following reasons:
one mold for all functions;
lower wear-related costs due to the process parameters and mold reduction;
increase in clock cycle rate since the component can be produced in a single working stroke;
reduction in investment: more compact open systems can be used, resulting in lower CO₂ emissions; pressing force is not increased since in lieu of two components in the mold, only one is present; all of the functions are carried out in the mold, i.e. the press can be simply designed.

The invention will be explained below in conjunction with the drawings.

### BRIEF DESCRIPTION OF THE DRAWINGS

FIG. 1 shows the method sequence of a dual-action process according to the invention.

FIG. 2 shows the design of a dual-action mold according to the invention.

FIG. 3 shows the forming forces as a function of the temperature.

FIG. 4 shows the temperature curve in the method according to the invention, with a starting temperature of 700° C.

FIG. 5 shows the temperature curve in the method according to the invention, with a starting temperature of 500° C.

FIG. 6 shows the oxidation rate of iron in air.

FIG. 7 shows the hardening with a 180°-folding of TMT steel.

FIG. 8 shows the hardness curve of quenched, tempered steel (V) and thermomechanically rolled steel (TMBA).

FIG. 9 shows the mechanical characteristic values of thermomechanically rolled steel as a function of the annealing temperature.

FIG. 10 shows the manufacture of components according to a first embodiment of the method according to the invention.

FIG. 11 shows the manufacture of components according to a second embodiment of the method according to the invention.

FIG. 12 shows the manufacture of components according to a third embodiment of the method according to the invention.

FIG. 13 shows the manufacture of components according to a fourth embodiment of the method according to the invention.

FIG. 14 shows a comparison of thermomechanically rolled steel and normalized annealed steel.

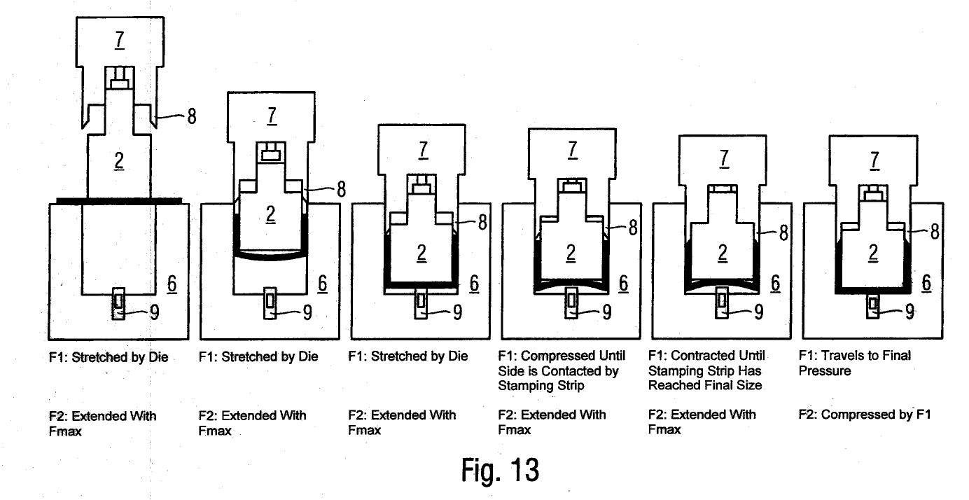

FIG. 15 shows the yield point and carbon equivalent for different manufacturing methods and steel types.

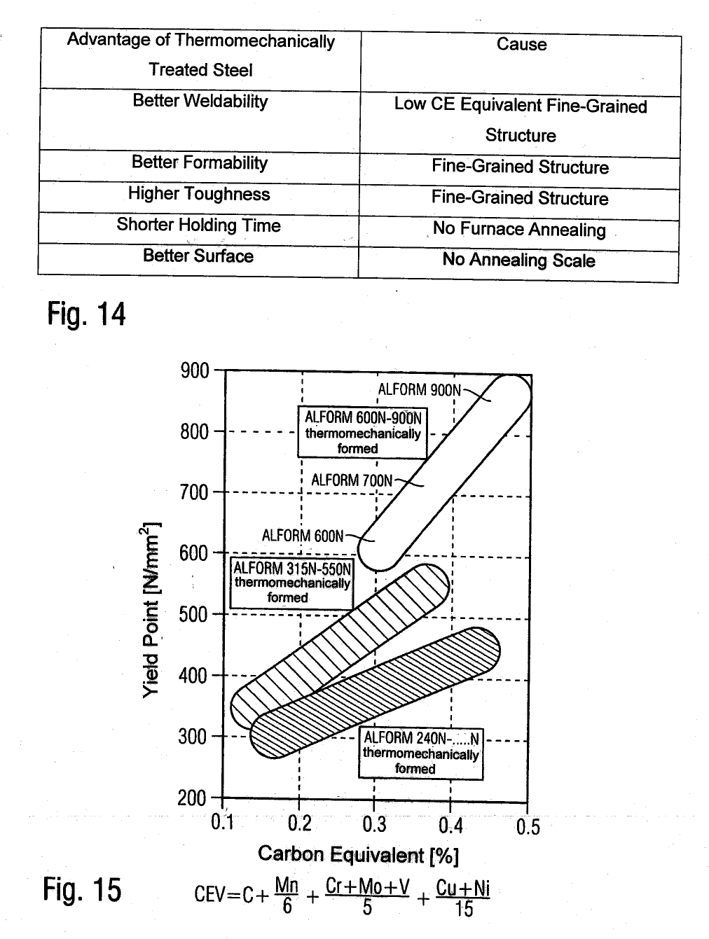

FIG. 16 shows the manufacture of hot rolled steel.

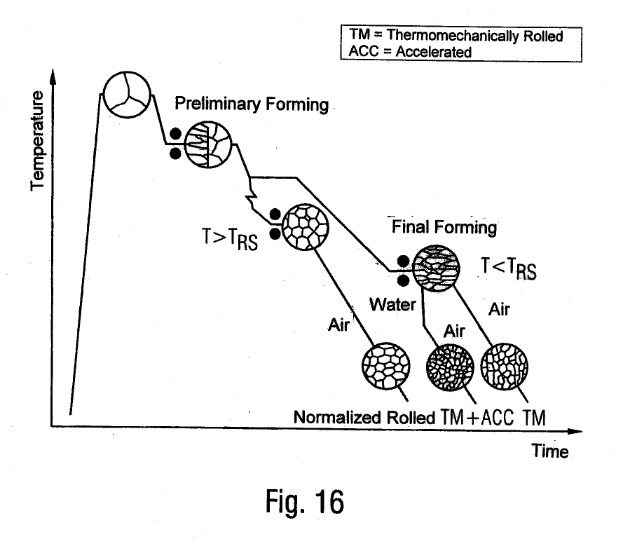

FIG. 17 shows the structure based on different manufacturing methods of hot rolled steel.

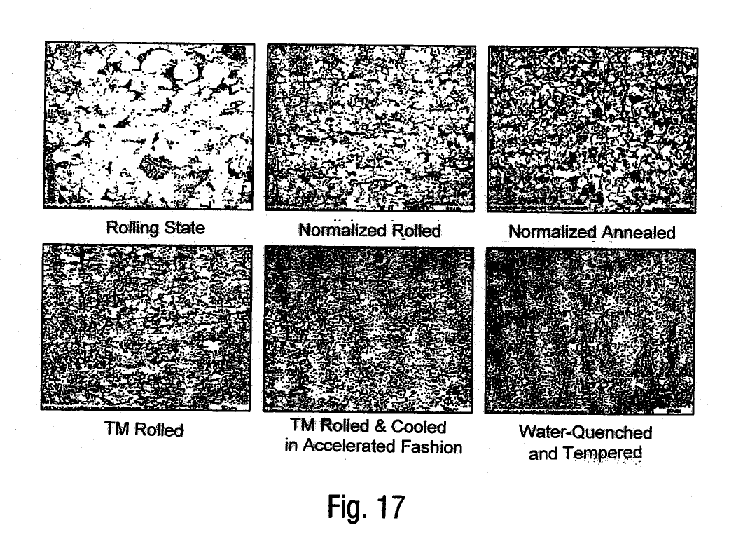

FIG. 18 shows the method sequence of a two-stage process according to the prior art.

FIG. 19 shows the temperature curve during hot forming according to the prior art, with a starting temperature of 940° C. in comparison to an air cooling.

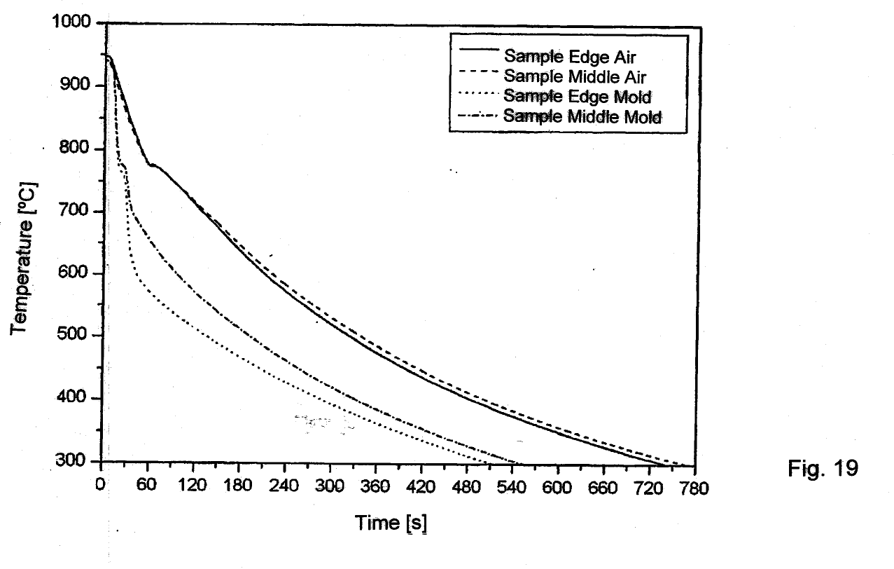

FIG. 20 shows the temperature curve during hot forming according to the prior art, with a starting temperature of 940° C.

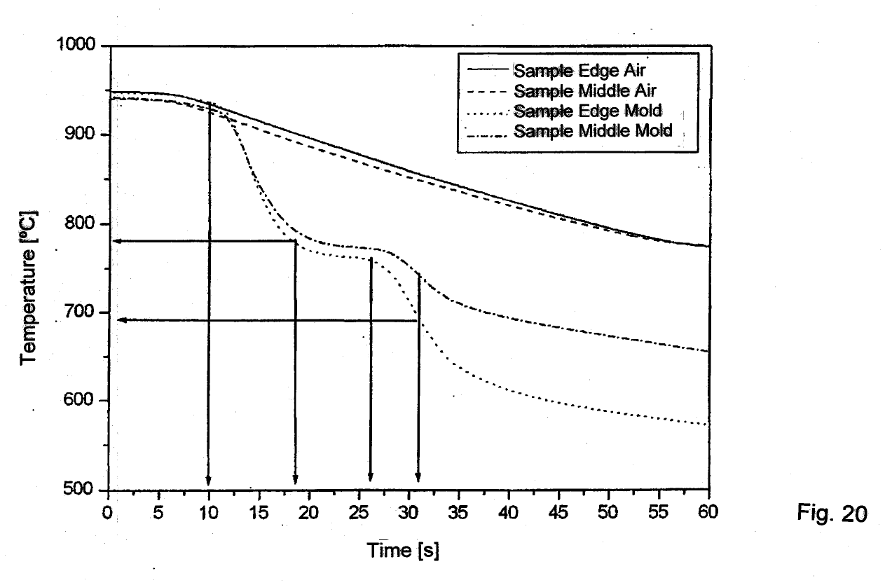

### DETAILED DESCRIPTION OF THE PREFERRED EMBODIMENTS

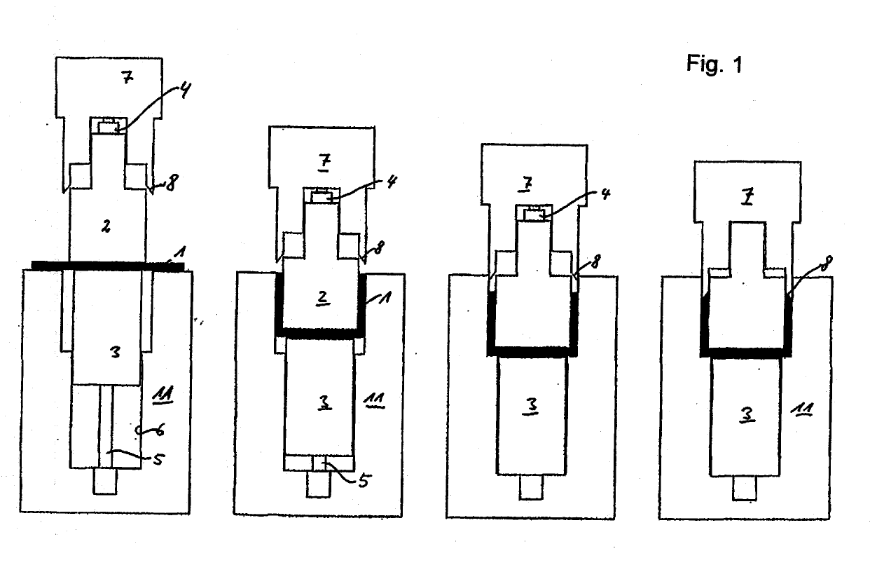

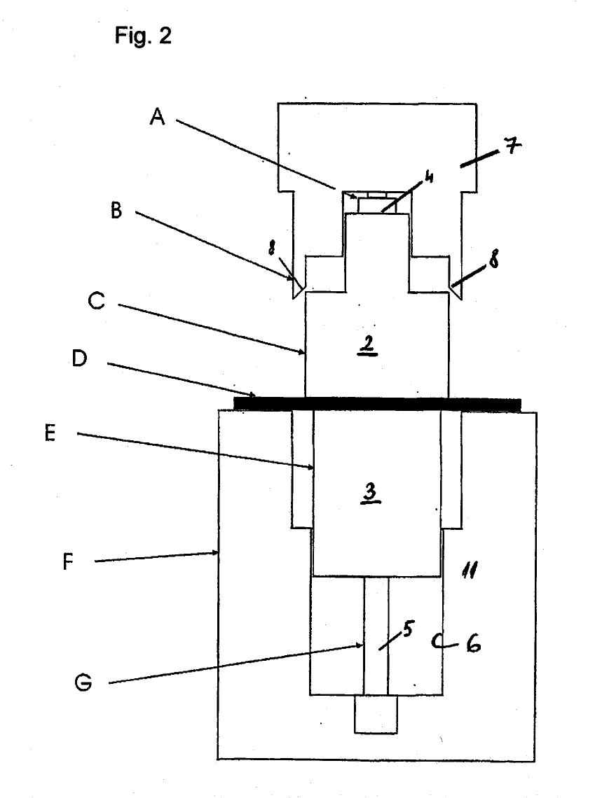

FIGS. 1 and 2 show the design of the mold. Depending on the type of application, the mold parts can also be provided with a cooled design.

The top part 7 contains the die 2, which produces the shape of the component, and the stamping strips for stamping small radii and if necessary, performing the weld. The die 2 is connected to the top part 7 via a spring packet 4. This spring packet can be composed of steel springs, hydraulic spring/damper systems, or gas compression springs. The bottom part 11 contains the female die insert 3 and the female die 6 itself. The spring packet 5 for controlling the female die insert 3 can likewise be composed of steel springs, hydraulic spring/damper systems, or gas compression springs.

The manufacture of a component by means of a dual-action process can be explained as follows:

The blank 1, which can be close to the final geometry if so desired, is supported on the bottom part 11 of the mold on the one hand and on the female die insert 3 on the other. If the top part 7 touches the blank 1, then the dual-sided contact of the top part 7 and the female die insert 3 clamps the blank 1 and the forming occurs in a guided fashion that is not free-floating. In addition, this does not allow any dishing to occur in the mold. In the subsequent forming (step 2), the die 2 then pushes on the female die insert 3. The forces of the spring packet of the die 2 here are matched to the female die insert 3 so that no impressions are produced in the blank 1. In step 3, the component is completely formed; the die 2 has reached the bottom dead center here. At the same time, the female die insert 3 is now supported in the female die 6 so that the stamping forces do not have to be transmitted via the spring packet 5. As the sequence continues, the spring packet 4 in the die 2 is then compressed and the stamping is carried out (step 4). After the opening of the mold, the spring force of the female die insert 3 serves to eject the component, i.e. the mold once again assumes the position in step 1.

The manufacture of a component with sharp radii and/or welding seam preparation therefore occurs in one stroke or working step of the mold. A processing of the welding edge permits the reuse of parts for component production, without a material-removing intermediate processing of the edge.

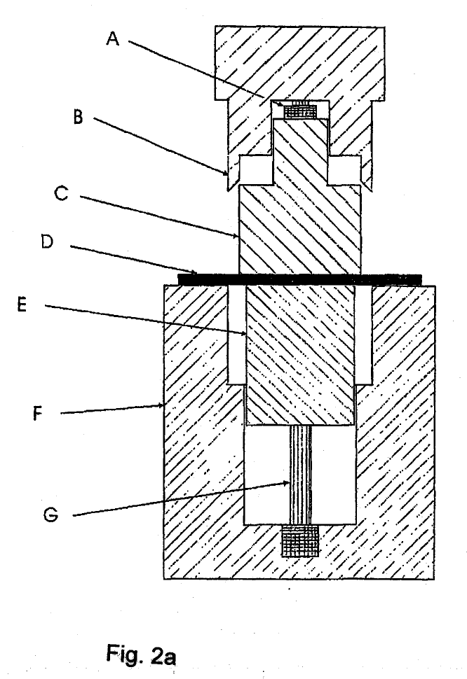

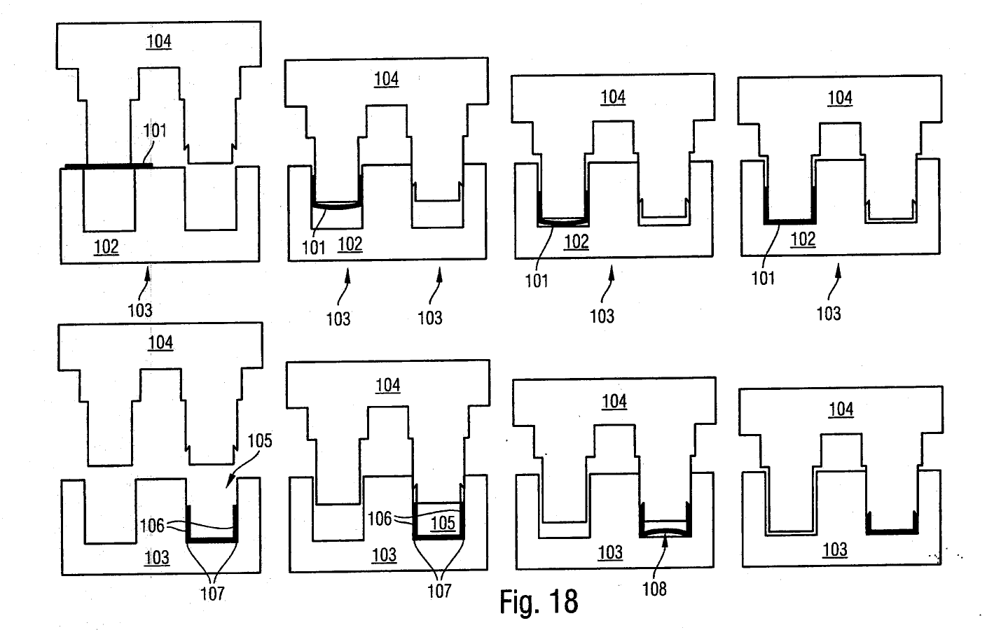

Depending on the starting material, the blanks can be heated to temperatures between 500° C. and 700° C. FIG. 3 shows the required forming forces as a function of temperature in an identical component. This graph shows that a hot forming at 900° C. cuts the pressing forces in half by comparison with a temperature-controlled forming. But since in the two-stage process of the hot forming, the final temperature drops to approximately 700° C., the forming forces also rise to approximately 1.5 times ( [symbol] line). But if one also considers the fact that two components are situated in the press, then it can be assumed that the press must be laid out similar to one used for temperature-controlled forming. In addition, the increased friction at 900° C. is clearly evident. Whereas at lower temperatures, the force level decreases after the first forming, at 900° C., the forming resistance remains approximately constant, which indicates increased friction due to the presence of scale in the side region. This phenomenon occurs during the forming in step 2 in FIG. 18.

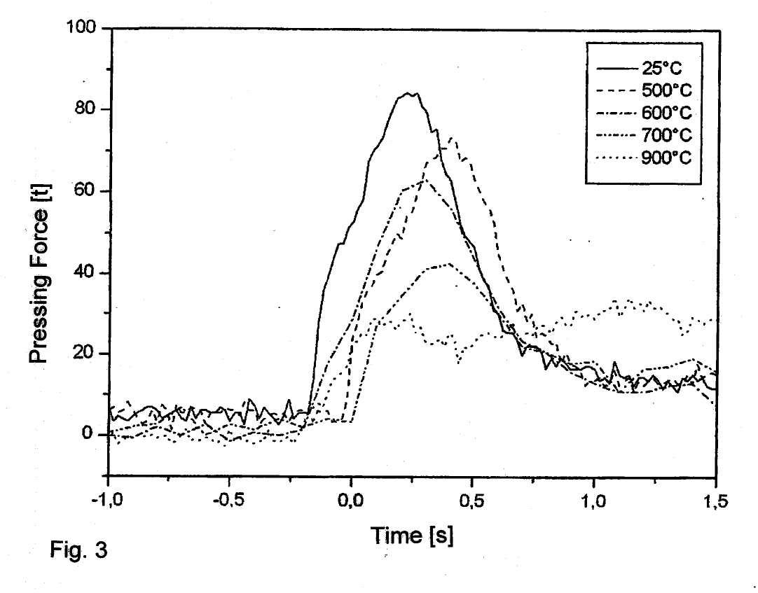

FIG. 4 shows the temperature curve of the temperature-controlled forming according to the invention in the example of a forming at 700° C. On the one hand, it is clear that the manufacture of the component has occurred in one step; on the other hand, a maximum temperature loss of only approximately 120° C. occurs in the course of this. In comparison to hot forming, it is clear that a reduction of the starting temperature by approximately 240° C. yields a reduction of the end temperature by only 100° C.

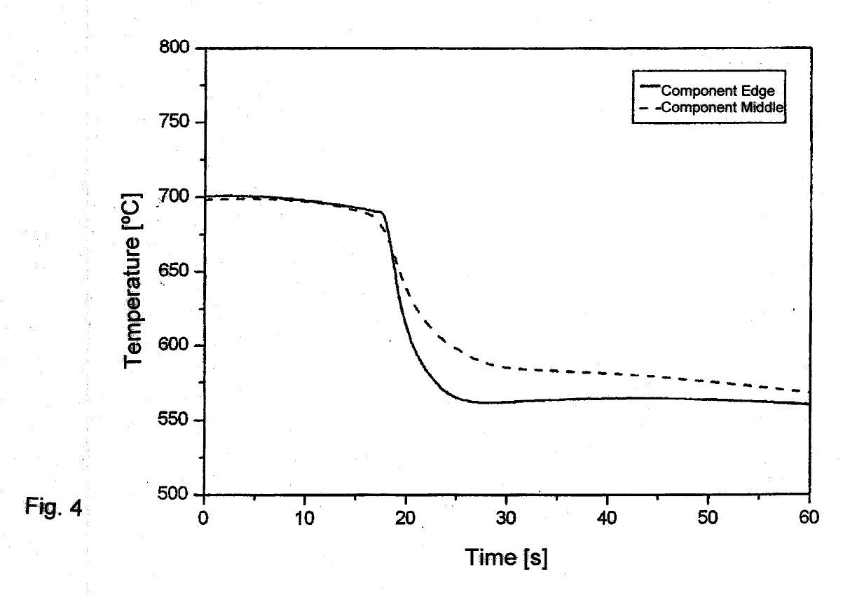

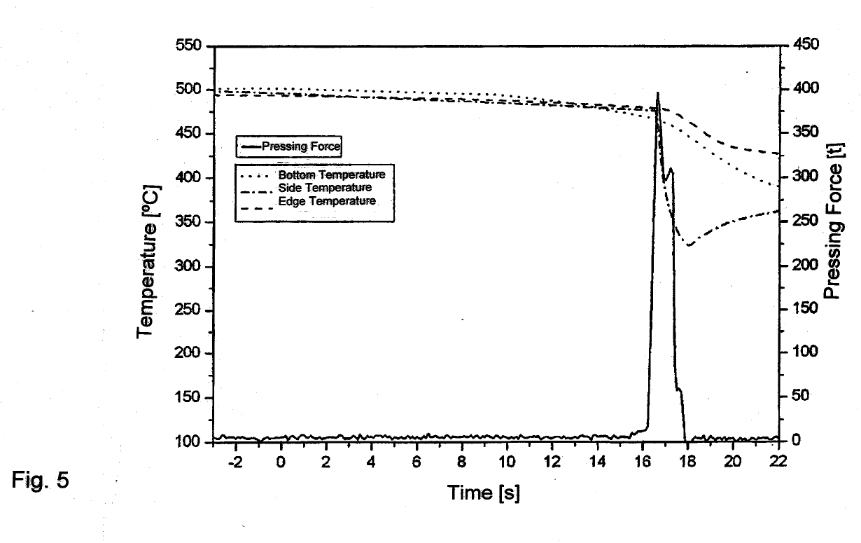

FIG. 5 shows another example. In this case, the blank temperature at the start of the forming process was 500° C. The evaluation shows that in the region of the bottom and the side, the temperature loss is less than 100° C., whereas in the region of the edge, i.e. at the location engaged by the stamping strips, a reduction of the forming temperature by more than 150° C. occurs. Because of the thermal conduction in the component, however, an immediate increase in the temperature occurs after the opening of the press. FIG. 6 shows the oxidation rate of iron in air as a function of the temperature. If the oxidation rate at 600° C. is taken as a reference value, then at 700° C., the rate increases sevenfold and at 950° C., it increases 230-fold. This clearly demonstrates the advantage of the temperature-controlled forming according to the invention. The drastic reduction in oxide formation on the component surface reduces the wear on the mold. The second cost effect is the increase in clock cycle rate since the intermediate cleaning of the mold is reduced by a large amount or can be eliminated entirely.

The method according to the invention can only be implemented through the combination of temperature guidance and material selection.

In comparison to cold forming, significantly more complex geometries are possible. This is due to a replenishing supply of the material during the forming. As a result, significantly smaller external and internal radii can be produced while maintaining the initial cross-section of the primary material. It is therefore possible, with the same mechanical properties of the material, to transmit greater loads since it is possible to sharply increase the surface section moduli. With the same load, the wall thickness can be correspondingly reduced, thus achieving weight savings.

In conventional cold forming, the material is thinned in the deforming region.

As has already been mentioned, the cooling speed only exerts a slight influence on the mechanical properties of the material after the forming, whereas when normalized rolled steels are used, the cooling speed is an essential function for achieving the mechanical properties.

When annealing conditions are maintained for the forming, the yield point rises due to accelerated aging effects. Furthermore, precipitation phenomena can also occur.

Short-term temperatures of the kind that occur for example in flame-straightening, can be maintained in a fashion analogous to those of the initial material, provided that they are maintained in accordance with supplier specifications for the primary material.

Because of the selected temperature range for the forming, it is possible to use any material that retains its properties through a temperature-controlled heat treatment. This is likewise true for normalized rolled steels if a special finishing requires the use of these steels.

Preferably, thermomechanical steels are used since the already favorable forming capacity at room temperature is improved by the temperature-controlled forming and the method can be supplemented by upsetting processes.

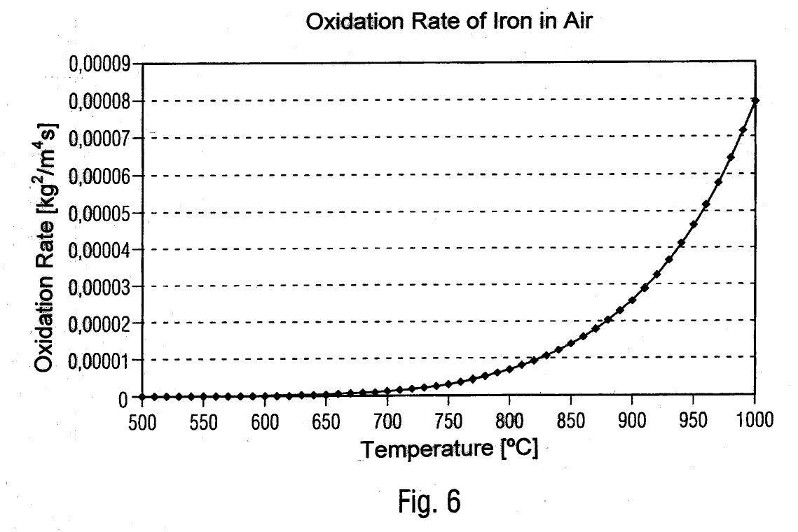

In comparison to cold forming, only slight hardening effects occur in the temperature-controlled forming since the forming occurs in the vicinity of the material's recovery and therefore the hardening can be reduced without incubation time. The result is a homogenization of the internal stresses. A reduction in the hardening is clear from FIG. 7.

The temperature-controlled forming according to the invention does not limit further processing in terms of welding or surface coatings. This method permits the manufacture of complex components with high strengths without limitation as to subsequent processes. Because of the hot forming, it is only possible, for example, to use normalized rolled steels. As has already been described above, the alloy composition of these steels makes them significantly more critical from a weld standpoint. In addition, due to the high temperature, cleaning the surface is significantly more complex.

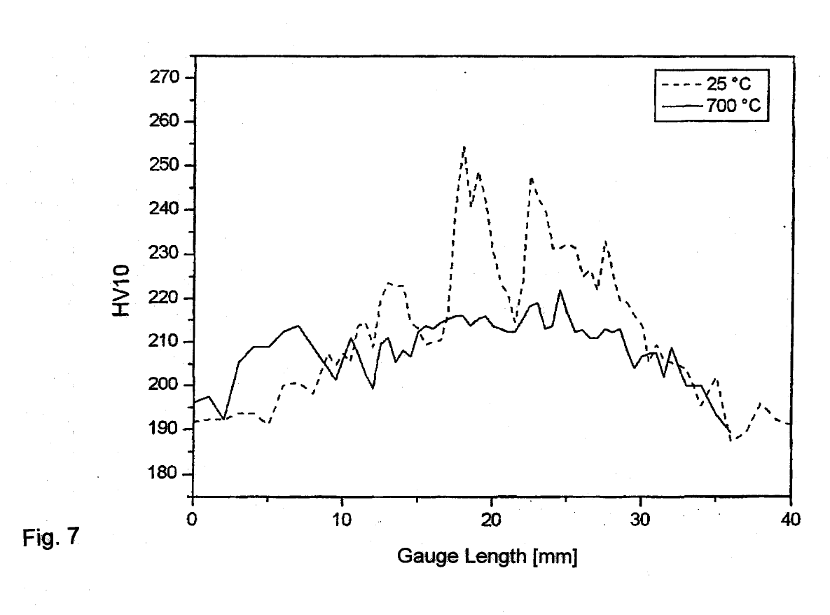

The basic reason for the bias against the use of thermomechanical steels is their sensitivity to high temperatures of the kind that can occur during welding, for example. Due to their alloy composition, however, modern TMT steels also have very good mechanical properties after welding. This is achieved among other things through the addition of micro-alloy elements. Through finely distributed precipitations of micro-alloy elements in combination with nitrogen or carbon, the formation of coarse grain in the thermal influence zone is hindered since an expansion of the grain boundaries is impeded by adhesion. As a result, the softened zone is very thin, as shown on the right side in FIG. 8 (WEZ=thermal influence zone, SG=welding metal deposit). In both cases, the decrease in hardness is equal; the softening zone is significantly thinner in thermomechanically rolled steel. This is necessarily due to the fact that below AC1 (the eutectoid temperature), no softening of the material occurs, i.e. the grain size does not change. Above AC1, a transformation into austenite occurs, followed by the above-described coarse grain formation.

In quenched, tempered steel (V), the softening zone is significantly thicker since transformations occur even below AC1. In this case, tempering effects occur, consequently changing the mechanical properties of the material. In addition, due to the higher carbon content, an increased carburization also occurs in the transition region from the melted material into the thermal influence zone. This is particularly critical under dynamic stress since this functions as a metallurgical notch.

The invention will be described in greater detail below in conjunction with exemplary embodiments; a special material selection has not been made here so that all of the materials described above can be processed using the method according to the invention.

The method enables, so to speak, the use of normalized steels, with the prerequisite that the annealing conditions are maintained in a fashion analogous to that used in low-stress annealing. During production, however, a recrystallization during the forming must be avoided since this is accompanied by a reduction in strength. If steels are used that have a strong tempering tendency, e.g. due to martensitic phases, then a loss in strength must be expected.

### Example 1

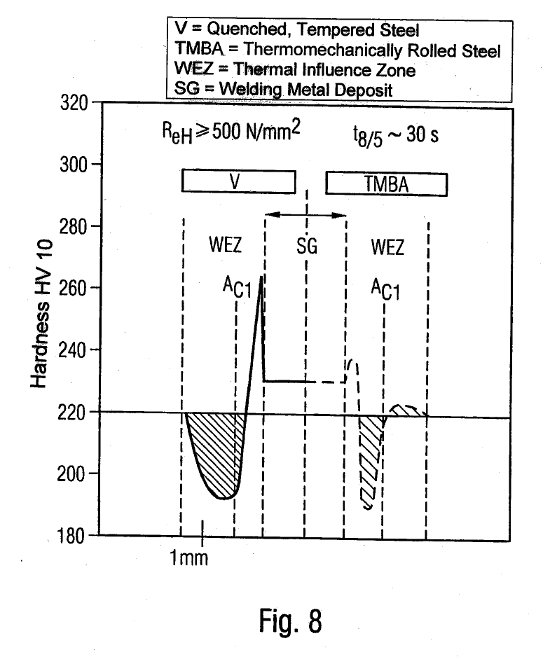

FIG. 9 shows an example for the use of a thermomechanically rolled steel for the temperature-controlled forming. The samples were heated to the respective temperatures within 15 minutes. In all cases, it was possible to establish a complete, thorough heating. Then the samples were cooled in air, in water, or between two cooled copper plates. The evaluation shows that up to a temperature of 700° C., the mechanical properties correspond at least to the initial values. An increase in the yield point is necessarily due to an accelerated aging. Above 700° C., a change in the structure occurs as the formation of austenite begins. The result is a softening of the thermomechanically rolled steel.

The above-described method for manufacturing components by means of temperature-controlled forming can be carried out with different mold embodiments. Furthermore, the functions of springs, hydraulic dampers, and gas compression springs can also be performed by the press itself. Depending on the number of pieces to be produced and the precision of the components, it is possible to carry out a water cooling in the molds. By contrast with hardening in water-cooled molds, in this case, it is not necessary to achieve that kind of cooling speeds. The cooling should protect the mold and its functions from thermal strain.

All of the methods share the simplification that both the forming and the stamping of the lateral edges occur in one step. None of the embodiments requires an additional ejection device that could potentially ruin the contour or the surface of the component. At the same time, lateral clamps on the female die insert prevent the component from sticking to the die. These clamps open automatically when the mold opens or can be triggered by means of hydraulics or gas.

### Example 2

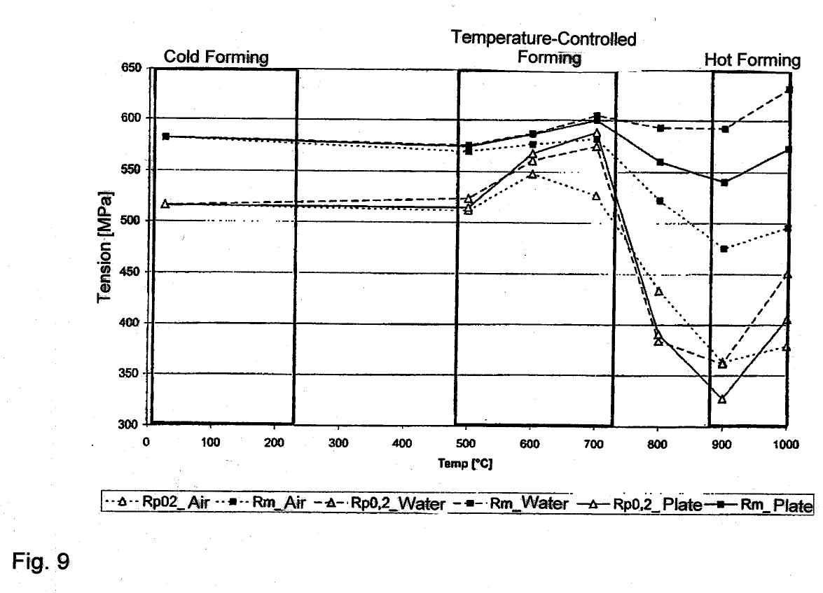

The process sequence is shown in FIG. 10.

Step 1: At the start of the forming, the blank 1 is clamped between the die 2 and the female die insert 3. It is thus possible to prevent the blank from slipping. In conventional methods, because no female die insert is used, the forming occurs in a free-floating fashion, in other words the blank is not guided. In the classic hot forming, flaking scale can influence the function of the female die insert. Spring 4 and spring 5 are prestressed.

Step 2: The forming occurs in the clamped state. Spring 4 is prestressed; spring 5 is compressed by the die 2.

Step 3: The die and the female die insert reach the bottom dead center. If no welding work at the edges or thickened corner regions is required, then step 4 can be skipped. Spring 4 is prestressed, spring 5 is compressed by the die, and the female die insert 3 rests against the female die 6.

Step 4: In order to reduce costs, the processing die 7 with stamping strips 8 can process the welding edge in this work step, independent of the welding process and the angle required for it. At the same time, the radii of the corners can be reduced on both the inside and the outside. In addition, the wall thickness is increased in this region. Spring 4 is compressed by the stamping strips; spring 5 remains in position.

Step 5: The female die insert 3 simultaneously serves to eject the component and in this position, is able to receive the next blank.

Advantages:
no free-floating forming thanks to the female die insert;
stamping occurs only when the component is situated at the bottom dead center, i.e. the stamping does not shift any material into the bottom—smaller upsetting distance than in the prior art (see FIG. 18);
simple mold design, i.e. only one spring system in the die required;
low mold costs;
no additional path-dependent control in the mold required.

Example 3

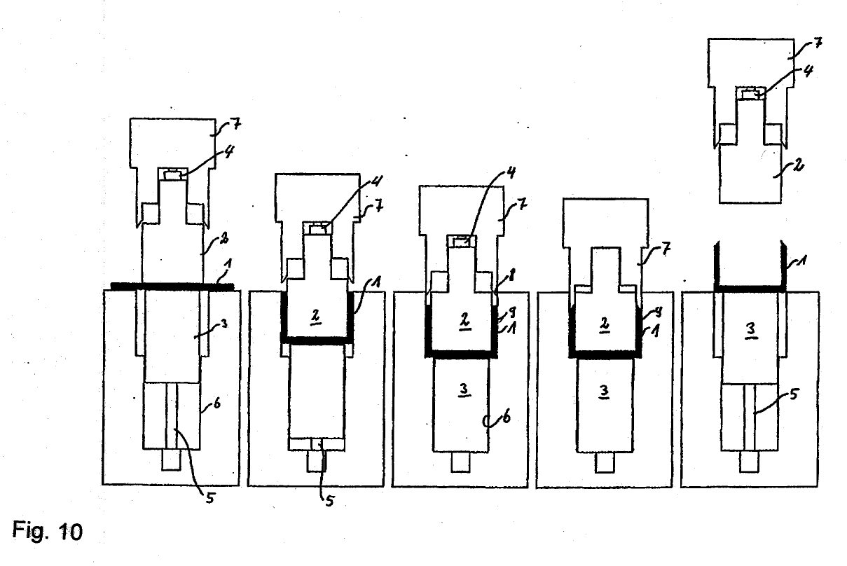

The process sequence is shown in FIG. 11.

Step 1: The blank 1 is clamped between the female die 6 and the die 2. Depending on the component, a female die insert can assist with the clamping (not shown). F1, F2, and F3: see notes in FIG. 11.

Step 2: The components are formed in a free-floating fashion without a female die insert. F1, F2, and F3: no change.

Step 3: The die 2 is retracted; this occurs through the control of F1. Stamping strips 8 come into contact with the side. F2 and F3 remain unchanged.

Step 4: With the adjustment made in step 3, the system travels into contact with the bulge-producing device 9.

Step 5: The corners 10 of the component come into contact with the bottom of the female die. This causes a stockpiling of the material in the bottom. F1, F2, and F3 analogous to step 3.

Step 6: The top part 7 travels downward; F3 is completely compressed. F2 is compressed in proportion to this amount. This causes a displacement of the material into the corners without the occurrence of a high friction in the side region.

Step 7: Stamping of the component through complete compression of F3.

Advantages:
stockpiling of material in the bottom;
low wear in the side;
little upsetting via the side required.

### Example 4

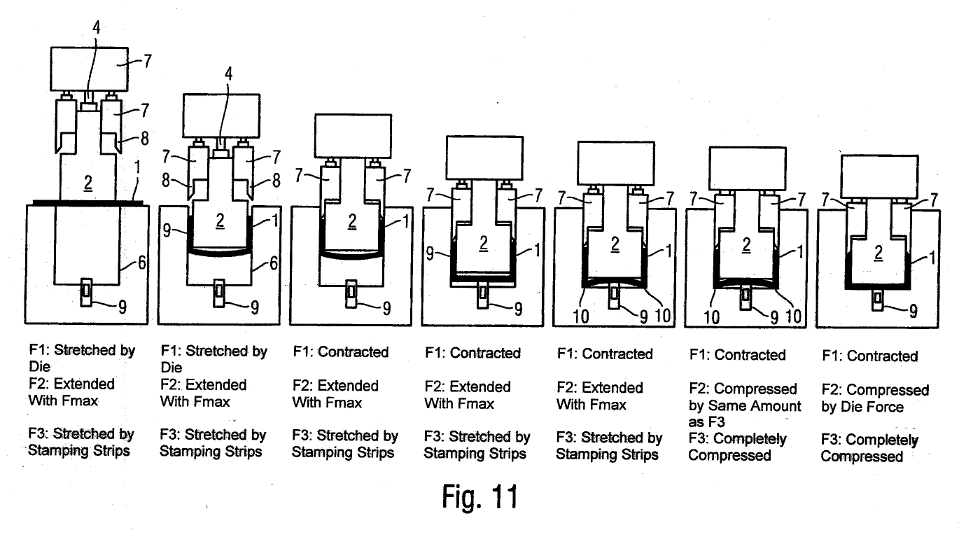

The process sequence is shown in FIG. 12.

Step 1: The blank 1 is clamped between the female die 6 and the die 2. Depending on the component, a female die insert can assist with the clamping (not shown). F1 and F2: see notes in FIG. 12.

Step 2: The component is formed in a free-floating fashion without a female die insert. F1 and F2: no change.

Step 3: The bottom region is clamped between the die 2 and the bulge-producing device 9. F1 and F2 no change.

Step 4: F1 is compressed by the downward motion of the top part 7 so that the stamping strips 8 press the component into the female die 6 in the corner region. F2 remains unchanged.

Step 5: The die 2 and stamping strips 8 travel downward simultaneously and stamp the component. This compresses F2.

Advantages:
simple mold design, i.e. only one spring system in the die required;
low mold costs;
no additional path-dependent control in the mold required.
stockpiling of material in the bottom region by means of the bulge-producing device.

### Example 5

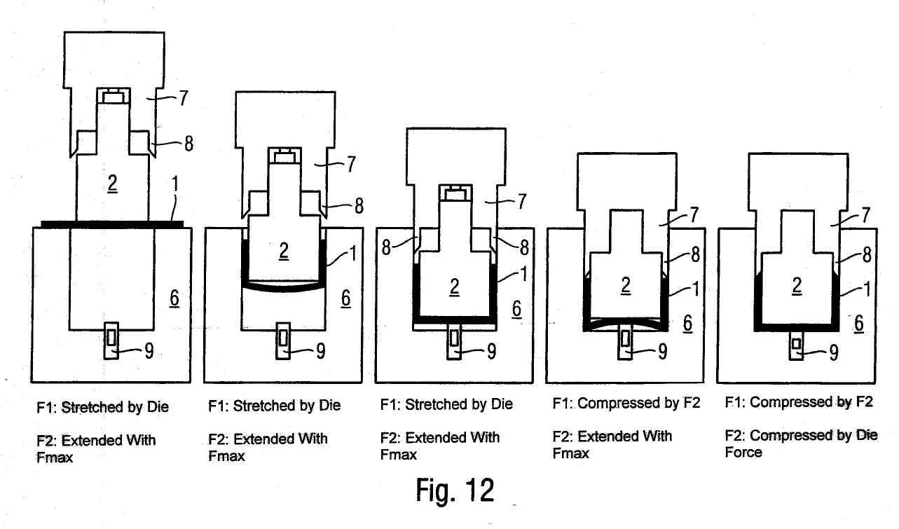

The process sequence is shown in FIG. 13.

Step 1: The blank 1 is clamped between the female die 6 and the die 2. Depending on the component, a female die insert can assist with the clamping (not shown). F1 and F2: see notes in FIG. 13.

Step 2: The components are formed in a free-floating fashion without a female die insert. F1 and F2: no change.

Step 3: The bottom region is clamped between the die 2 and the bulge-producing device 9. F1 and F2 no change.

Step 4: The die 2 holds its position through controlled compression of F1. The top part 7 travels downward so that the stamping strips 8 press the component into the female die 6 in the corner region. F2 remains unchanged.

Step 5: The stamping strips travel to the final dimension of the component and the die remains in a constant position; F1 controls the relative movement in relation to the stamping strip so that the die position remains constant. F2 remains unchanged.

Step 6: Stamping of the component through extension of the die by means of F1. This compresses F2.

Advantages:
top part requires only one spring system;
low mold costs;
stockpiling in the bottom region regardless of the upsetting height of the stamping strips.

With the invention, it is advantageous that a method and an apparatus are created with which a guided forming, including the upsetting of material, stamping of welding edges, and component ejection is carried out reliably, quickly, and safely in a single mold; because of the process guidance, particularly the low temperatures, reduced wear occurs, the clock cycle rate is increased, and more compact furnace systems can be used. In addition, scale formation is reduced, which reduces finishing work and offers the possibility of producing complex components out of higher-strength TMT steels.

Bare sheet metal or also coated sheet metal can be used as the sheet steel for the blanks.

Suitable coatings include electrolytically galvanized coatings or a wide variety of hot dip galvanized coatings, possibly with an alloying step, zinc/aluminum or aluminum/zinc coatings, aluminum coatings, or also nano-coatings, etc.

1. A method for forming sheet steel, comprising:
producing a blank from the sheet steel by inserting the blank into a forming mold to produce a formed work piece from the blank in a single-step process that includes heating the blank before the forming, with the steel being heated to a temperature at which it does not undergo any phase transformation, and the forming takes place in the ferritic, perlitic, or bainitic range, without exceeding the eutectoid or recrystallization temperature.

2. The method as recited in claim 1, comprising using a steel that has a stable structure at temperatures up to a maximum of 700° C. as the steel.

3. The method as recited in claim 1, comprising using a normalized rolled steel, a normalized annealed steel, or a thermomechanically rolled steel as the steel material.

4. The method as recited in claim 1, comprising heating the steel to a temperature of 400° to 800°.

5. The method as recited in claim 1, comprising inserting the blank between a forming mold top part and a forming mold bottom part;
wherein the top part is equipped with a die that produces the form of the component and also has stamping strips for stamping small radii and, if so desired, for carrying out welding work; and
the forming mold bottom part has a female die insert as well as the female die itself;
clamping the blank by touching of the top part with the dual-sided contact of the top part and the female die insert; and
carrying out the forming;
wherein, as the deformation continues, the die displaces the female die insert and the component is completely formed once the die has reached the bottom dead center; the female die insert is supported in the female die and then a stamping is carried out.

6. The method as recited in claim 1, comprising using bare or coated sheet steel as the sheet steel for the manufacture of the blanks.

7. The method as recited in claim 6, wherein the coated sheet steel is selected from the group consisting of electrolytically galvanized sheet steel, hot dip galvanized sheet steel (fire-galvanized sheet steel), a hot dip coated sheet steel with a hot dip coating of zinc and aluminum or of aluminum and zinc, and possibly other metals, a coating essentially of aluminum and silicon, and a coating of zinc that has been alloyed with the steel in an alloying step.

8. An apparatus for the temperature-controlled forming of a steel blank in which the blank is inserted into a forming mold and the forming mold produces the formed work piece from the blank, the apparatus comprising:
a top part and a bottom part, with the top part containing a die, which produces the form of a component;
stamping strips for stamping small radii and, if so desired, for carrying out welding work, with a first spring packet connecting the die to the top part; and
a bottom part in which a female die insert and a female die itself are situated, with a second spring packet provided for controlling the female die insert.

9. The apparatus as recited in claim 8, wherein the first and second spring packets comprise metal springs, in particular steel springs; hydraulic springs; damper systems; or gas compression springs.

10. The apparatus as recited in claim 8, further comprising a bulge-producing device at the bottom of the female die.

11. A method for forming sheet steel, comprising:
producing a blank from the sheet steel by inserting the blank into a forming mold to produce a formed work piece from the blank in a single-step process that includes heating the blank before the forming, with the steel being heated to a temperature at which it does not undergo any phase transformation, and the forming takes place in the ferritic, perlitic, or bainitic range, without exceeding the eutectoid or recrystallization temperature; and
stamping, welding, or upsetting through the use of stamping strips, the lateral edges of the formed work piece in order to stamp small radii and/or to increase the wall thickness in this region.
